(19) United States
(12) Patent Application Publication
(10) Pub. No.: US 2026/0364819 A1
(43) Pub. Date: Nov. 19, 2026

(54) DIRECT-DRIVE FINGER AND FULLY DIRECT-DRIVE DEXTEROUS HAND

(71) Applicant: Talls Intelligent Technology (Shenzhen) Co., Ltd., Shenzhen (CN)

(72) Inventors: Yulong TAO, Shenzhen (CN); Lei TAO, Shenzhen (CN); Yangyang LI, Shenzhen (CN); Zekai TAO, Shenzhen (CN)

(73) Assignee: Talls Intelligent Technology (Shenzhen) Co., Ltd., Shenzhen (CN)

(21) Appl. No.: 19/432,896

(22) Filed: Dec. 24, 2025

(30) Foreign Application Priority Data
May 19, 2025 (CN) 202510643809.4

(51) Int. Cl. B25J 15/00

(52) U.S. Cl. CPC B25J 15/0009

(57) ABSTRACT

A direct-drive finger includes a first mounting seat connected to a palm portion, and a first joint, a first finger bone, a second joint, and a second finger bone connected sequentially outward. The first joint includes a first drive unit having a first housing, a first motor, and a first rotating shaft. The first finger bone is fixed to the first housing, which is connected to the first mounting seat via the first rotating shaft. The first motor drives the first housing through the first rotating shaft to rotate the first housing relative to the first mounting seat, enabling the direct-drive finger to rotate towards an inner palm face. The second joint drives the second finger bone to bend the direct-drive finger towards the inner palm face.

### CROSS-REFERENCE TO RELATED APPLICATIONS

The present application claims priority to Chinese Patent Application No. 202510643809.4, filed on May 19, 2025, which is hereby incorporated by reference in its entirety.

### TECHNICAL FIELD

The present application relates to the technical field of dexterous hands, and in particular to a direct-drive finger and a fully direct-drive dexterous hand.

### BACKGROUND

Fingers in existing dexterous hands adopt a screw rod and moving rod structure when bending, rotation of the screw rod can drive the moving rod to reciprocate along an axial direction of the screw rod, thereby pushing and pulling finger joints to realize bending of the finger joints.

However, the adoption of the screw rod and moving rod structure has the following problems: first, due to the limitation of the length of the screw rod itself, the finger joint cannot perform rotation to a maximum extent; second, the manner of adopting the screw rod and moving rod structure occupies a relatively large space within the finger joint, which is not convenient for miniaturized design of the finger, and consequently not convenient for miniaturized design of the dexterous hand.

### SUMMARY

In order to solve at least one of the above technical problems, an objective of the present application is to provide a direct-drive finger and a fully direct-drive dexterous hand.

To achieve the above objective, the finger provided by the present application is applied to a dexterous hand. The dexterous hand includes a palm portion, and the finger is mounted to the palm portion. The finger includes: a first mounting seat connected to the palm portion; and a first joint, a first finger bone, a second joint, and a second finger bone connected in sequence in a direction extending away from the palm portion; the first joint includes a first drive unit, and the first drive unit includes a first housing, a first motor, and a first rotating shaft provided at the first housing; the first finger bone is fixedly provided at the first housing; the first housing is connected to the first mounting seat via the first rotating shaft; and the first motor is configured to drive the first housing via the first rotating shaft to cause the first housing to rotate relative to the first mounting seat around an axis of the first rotating shaft, and to drive the direct-drive finger to rotate towards an inner palm face; and the second joint is configured to drive the second finger bone to cause the direct-drive finger to bend towards the inner palm face.

In an embodiment, the first drive unit further includes a first transmission assembly; the first motor is provided at the first housing; the first rotating shaft is fixedly provided at the first mounting seat; and the first transmission assembly is connected to the first rotating shaft and the first motor, to increase a torque transmitted from the first motor to the first rotating shaft; and the first finger bone includes two first connecting plates, and the first drive unit is provided between the two first connecting plates.

In an embodiment, the second joint includes a second drive unit, and the second drive unit includes: a second housing, a second rotating shaft provided at the second housing, a second motor, and a second transmission assembly, the second rotating shaft is fixedly provided at the first finger bone; the second transmission assembly is connected to the second rotating shaft and the second motor, to increase a torque transmitted from the second motor to the second rotating shaft; and the second motor is configured to drive the second housing via the second rotating shaft, to cause the second housing to rotate around the second rotating shaft; and the second finger bone is configured to rotate following the second housing, and the second finger bone is fixedly provided at the second housing.

In an embodiment, the direct-drive finger further includes a third finger bone and a third joint; the third joint includes a third drive unit, and the third drive unit includes a third housing, a third rotating shaft provided at the third housing, a third motor, and a third transmission assembly, the third rotating shaft is fixedly provided at the second finger bone; the third transmission assembly is connected to the third rotating shaft and the third motor, to increase a torque transmitted from the third motor to the third rotating shaft; and the third motor is configured to drive the third housing via the third rotating shaft, to cause the third housing to rotate around an axis of the third rotating shaft; the third finger bone is fixedly provided at the third housing; the third finger bone is configured to rotate following the third housing, and the third finger bone is configured to cause the direct-drive finger to bend towards the inner palm face; and the second finger bone includes two second connecting plates, and the second drive unit and the third drive unit are provided between the two second connecting plates.

In an embodiment, the direct-drive finger includes a fourth drive unit fixedly provided at the palm portion, and the fourth drive unit includes a fourth rotating shaft, the fourth rotating shaft is configured to drive the first mounting seat to cause the direct-drive finger to swing, and cause two of said fingers to approach or move away from each other.

In an embodiment, the fourth drive unit further includes a fourth housing fixedly provided at the palm portion, a fourth motor provided at the fourth housing, and a fourth transmission assembly; the fourth rotating shaft is provided at the fourth housing; and the fourth motor is configured to drive the fourth rotating shaft via the fourth transmission assembly, and the fourth transmission assembly is configured to increase a torque transmitted from the fourth motor to the fourth rotating shaft.

A direct-drive finger is applicable to a dexterous hand including a palm portion, the direct-drive finger is configured to be mounted to the palm portion. The direct-drive finger includes: a second mounting seat provided at the palm portion; a drive module; a fifth joint provided at the second mounting seat; and a fifth finger bone; the drive module includes a seventh drive unit fixedly provided at the palm portion, and the seventh drive unit includes a seventh rotating shaft; the seventh rotating shaft is configured to drive the second mounting seat to rotate around an axis of the seventh rotating shaft, and the drive module is configured to place the direct-drive finger in a first position or a second position relative to the palm portion; in the first position, the fifth joint is configured to drive the fifth finger bone to cause a fingertip of the direct-drive finger to approach or move away from a peripheral side of the palm portion; and in the second position, the fifth joint is configured to drive the fifth finger bone to cause the fingertip of the direct-drive finger to approach or move away from an inner palm face of the palm portion.

In an embodiment, the seventh drive unit further includes a seventh housing, a seventh motor provided at the seventh housing, and a seventh transmission assembly; the seventh rotating shaft is provided at the seventh housing, and the seventh housing is fixedly provided at the palm portion; the seventh motor is configured to drive the seventh rotating shaft via the seventh transmission assembly, and the seventh transmission assembly is configured to increase a torque transmitted from the seventh motor to the seventh rotating shaft; the drive module further includes an eighth drive unit and a third mounting seat; the eighth drive unit includes an eighth housing, an eighth rotating shaft provided at the eighth housing, an eighth motor, and an eighth transmission assembly; the eighth housing is fixedly provided at the second mounting seat, and the eighth rotating shaft is configured to drive the third mounting seat to cause the third mounting seat to rotate around an axis of the eighth rotating shaft; the eighth motor is configured to drive the eighth rotating shaft via the eighth transmission assembly, and the eighth transmission assembly is configured to increase a torque transmitted from the eighth motor to the eighth rotating shaft; and the fifth joint is provided at the third mounting seat; in the first position, the eighth rotating shaft is parallel to the inner palm face; and in the second position, the eighth rotating shaft is perpendicular to the inner palm face.

In an embodiment, the fifth joint includes a fifth drive unit, and the fifth drive unit includes a fifth housing, a fifth rotating shaft provided at the fifth housing, a fifth motor, and a fifth transmission assembly; the fifth rotating shaft is fixedly provided at the third mounting seat; and in the first position, an axis of the fifth rotating shaft is provided perpendicular to a palm face; the fifth transmission assembly is connected to the fifth rotating shaft and the fifth motor and the fifth transmission assembly, to increase a torque transmitted from the fifth motor to the fifth rotating shaft; and the fifth motor is configured to drive the fifth housing via the fifth rotating shaft to cause the fifth housing to rotate around the fifth rotating shaft; the fifth finger bone is configured to rotate following the fifth housing, and the fifth finger bone is fixedly provided at the fifth housing; and the direct-drive finger further includes a sixth joint and a sixth finger bone; the sixth joint includes a sixth drive unit; the sixth drive unit includes a sixth housing, a sixth rotating shaft provided at the sixth housing, a sixth motor, and a sixth transmission assembly, and the sixth rotating shaft is fixedly provided at the fifth finger bone; the sixth transmission assembly is connected to the sixth rotating shaft and the sixth motor, to increase a torque transmitted from the sixth motor to the sixth rotating shaft; and the sixth motor is configured to drive the sixth housing via the sixth rotating shaft to cause the sixth housing to rotate around the sixth rotating shaft; and the sixth finger bone is configured to rotate following the sixth housing, and the sixth finger bone is fixedly provided at the sixth housing.

A fully direct-drive dexterous hand includes: a palm portion; at least one first finger provided at the palm portion; and at least one second finger; the first finger is the direct-drive finger as described above; and the second finger is the direct-drive finger as described above.

The present application further provides a fully direct-drive dexterous hand, comprising a palm portion, and at least one first finger and at least one second finger provided at the palm portion; the first finger is any one of the fingers comprising the first joint described above, and the second finger is any one of the fingers comprising the fifth joint described above.

### BRIEF DESCRIPTION OF THE DRAWINGS

To describe the technical solutions in the embodiments of the present application or in the related art more clearly, the following briefly introduces the accompanying drawings required for describing the embodiments or the related art. Apparently, the accompanying drawings in the following description show merely some embodiments of the present application, and those of ordinary skill in the art may still derive other drawings from these accompanying drawings without creative efforts.

FIG. 1 is a schematic structural view of a fully direct-drive dexterous hand according to an embodiment of the present application.

FIG. 2 is a schematic structural view of a first finger in the dexterous hand of FIG. 1.

FIG. 3 is a schematic structural view of a second finger in the dexterous hand of FIG. 1.

FIG. 4 is a schematic structural view of a drive unit in the dexterous hand provided by the present application.

FIG. 5 is a schematic structural view of the drive unit in the dexterous hand according to another embodiment of the present application.

FIG. 6 is a schematic exploded structural view of the drive unit in the dexterous hand according to an embodiment of the present application.

FIG. 7 is a cross-sectional view of the drive unit in the dexterous hand according to an embodiment of the present application.

FIG. 8 is a cross-sectional view of the drive unit in the dexterous hand according to another embodiment of the present application.

FIG. 9 is a schematic structural view of an embodiment of a toroidal enveloping worm according to an embodiment of the present application.

The realization of the objective, functional characteristics, and advantages of the present application will be further described with reference to the embodiments and the accompanying drawings.

### DETAILED DESCRIPTION OF THE EMBODIMENTS

The technical solutions in the embodiments of the present application will be clearly and completely described below with reference to the accompanying drawings in the embodiments of the present application. Apparently, the described embodiments are merely some embodiments of the present application, rather than all of the embodiments. Based on the embodiments in the present application, all other embodiments obtained by those of ordinary skill in the art without creative efforts shall fall within the protection scope of the present application.

It should be noted that if there are directional indications (such as up, down, left, right, front, rear...) in the embodiments of the present application, such directional indications are only used to explain the relative positional relationship, movement conditions, etc., between various components in a specific posture. If the specific posture changes, the directional indications will change accordingly.

In addition, if there are descriptions involving “first”, “second”, etc., in the embodiments of the present application, the descriptions of “first”, “second”, etc., are only used for descriptive purposes and cannot be understood as indicating or implying their relative importance or implicitly indicating the number of indicated technical features. Therefore, features defined with “first’’ and “second’’ may explicitly or implicitly include at least one of such features. In addition, if “and/or” or “and/or” appears in the full text, its meaning includes three parallel solutions. Taking “A and/or B” as an example, it includes solution A, or solution B, or a solution where A and B are satisfied simultaneously. In addition, technical solutions between various embodiments can be combined with each other, but must be based on what can be achieved by those of ordinary skill in the art. When a combination of technical solutions appears to be contradictory or cannot be realized, it should be considered that such a combination of technical solutions does not exist and is not within the protection scope required by the present application.

Fingers in existing dexterous hands adopt a screw rod and moving rod structure when bending, rotation of the screw rod can drive the moving rod to reciprocate along an axial direction of the screw rod, thereby pushing and pulling finger joints to realize bending of the finger joints;

However, the adoption of the screw rod and moving rod structure has the following problems.

First, due to the limitation of the length of the screw rod itself, the finger joint cannot perform rotation to a maximum extent.

Second, the manner of adopting the screw rod and moving rod structure occupies a relatively large space within the finger joint, which is not convenient for miniaturized design of the finger, and consequently not convenient for miniaturized design of the dexterous hand.

The present application provides a direct-drive finger applied to a dexterous hand. The dexterous hand includes a palm portion 100, and the finger is mounted to the palm portion 100.

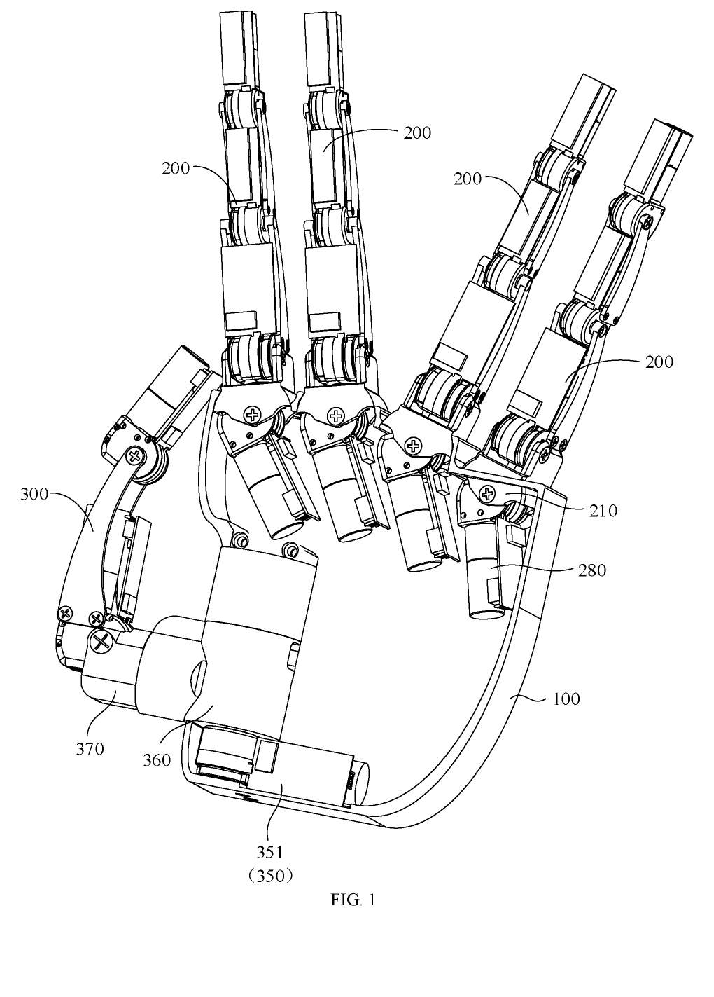

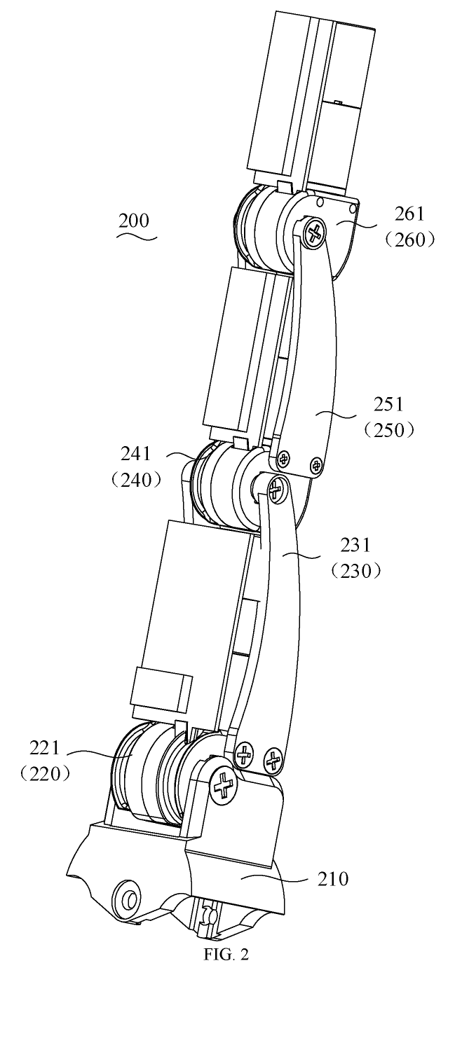

Referring to FIGS. 1 and 2, in an embodiment of the present application, the finger includes:
A first mounting seat 210 connected to the palm portion 100, the first mounting seat 210 can be rotatably provided at the palm portion 100 according to needs, or can be fixed to the palm portion 100; a first joint 220, a first finger bone 230, a second joint 240, and a second finger bone 250 connected in sequence in a direction extending away from the palm portion 100. It can be understood that connecting sequentially outward from the palm portion 100 can be understood as the first joint 220, the first finger bone 230, the second joint 240, and the second finger bone 250 being provided in sequence from the palm portion 100 and connected. It needs to be explained that the first joint 220 is provided at the first mounting seat 210, the first finger bone 230 is connected to the first joint 220 and the second joint 240, and the second finger bone 250 is provided at the second joint 240. It needs to be explained that in this embodiment, the finger has two joints and two finger bones, but this design is not limited thereto. In some embodiments, the finger further has a third joint 260 and a third finger bone. That is to say, the finger has three joints and three finger bones. Of course, for some needs, four joints and four finger bones can also be provided at the finger.

Further, the first joint 220 includes a first drive unit 221. The first drive unit 221 includes a first housing, a first motor, and a first rotating shaft provided at the first housing. The first finger bone 230 is fixedly provided at the first housing. The first housing is connected to the first mounting seat 210 via the first rotating shaft. The first motor drives the first housing through the first rotating shaft, so as to cause the first housing to rotate relative to the first mounting seat 210 around an axis of the first rotating shaft, and is configured to cause the finger to rotate towards an inner palm face. It needs to be explained that in this embodiment, the first rotating shaft is fixedly provided at the first mounting seat 210, and the first motor is fixedly provided at the first housing. When the first motor drives the first rotating shaft, at this time, the first rotating shaft does not move, and the first motor can rotate around the axis of the first rotating shaft. Since the first motor is fixedly provided at the first housing, when the first motor rotates around the axis of the first rotating shaft, it can drive the first housing to rotate around the axis of the first rotating shaft.

However, this design is not limited thereto. In some embodiments (not shown), the first motor is not provided at the first housing, but is placed outside the first housing and is fixed and immovable. At this time, the first rotating shaft can rotate. When the first motor drives the first rotating shaft to rotate, the first rotating shaft can drive the first housing to rotate around its own axis. It needs to be explained that since the first finger bone 230 is fixedly provided at the first housing, when the first housing rotates, it can drive the first finger bone 230 to rotate. According to different rotation directions, the purpose of the finger rotating towards the inner palm face can be achieved. At the same time, it needs to be explained that since the first housing rotates around the axis of the first rotating shaft during rotation, and the first motor causes the first housing to rotate through the first rotating shaft, thereby achieving the purpose of finger rotation.

It can be understood that, the manner of adopting the first motor to drive the first housing to rotate via the first rotating shaft, thereby driving the finger to rotate, compared with the related art which adopts a manner of pushing and pulling via a screw rod and a moving rod to drive the finger to rotate, can avoid limitations on physical stroke (the limitation of the length of the screw rod itself). Compared with the related art, it can increase a rotation angle of the finger, thereby solving the technical problems existing in the related art. At the same time, this embodiment adopts the first motor to drive the first rotating shaft to realize the rotation of the first housing, so as to realize the purpose of direct drive. Compared with the manner in the related art where a motor drives a rotating shaft and the rotating shaft drives a screw rod, this is more direct.

The second joint 240 is configured to drive the second finger bone 250, so as to cause the finger to bend towards the inner palm face. It needs to be explained that the second joint 240 includes a second drive unit 241. The second drive unit 241 can adopt the manner of a screw rod and a moving rod in the related art to drive the second finger bone 250 so as to cause the finger to bend towards the inner palm face, and can also adopt the structure of the first joint 220, adopting a manner where a motor drives a housing via a rotating shaft, so as to enable the second joint 240 to drive the second finger bone 250 to a maximum extent, causing the finger to bend towards the inner palm face. In this way, the bending degree of the finger can be made as large as possible, so that when the finger is in use, it can grasp more small tools, thereby improving the use effect of the dexterous hand.

Further, it can be understood that when the finger including the first joint 220 is applied to a dexterous hand, it can be used as an index finger, or a middle finger, or a ring finger, or a little finger.

In an embodiment, it needs to be explained that in the related art, in the manner of adopting a screw rod and a moving rod to drive a finger to rotate, there is a certain distance between the rotation axis of the finger and the connection point of the moving rod. This distance can form a force arm, thereby amplifying the gripping force produced by the finger. However, in the present application, in order to enable the first drive unit 221 to output a larger torque outward so as to improve the gripping force of the finger, further, the first drive unit 221 further includes a first transmission assembly provided thereon. The first motor is provided at the first housing. The first rotating shaft is fixedly provided at the first mounting seat 210. The first transmission assembly is connected to the first rotating shaft and the first motor. The first transmission assembly is configured to increase a torque transmitted from the first motor to the first rotating shaft. It can be understood that the first motor is connected to the first rotating shaft through the first transmission assembly. After the torque generated by the first motor passes through the first transmission assembly, it can be amplified, thereby causing the amplified torque to be manifested on the first rotating shaft. When the first rotating shaft fixes the first mounting seat 210, at this time, when the first motor drives the first housing to rotate, it can drive the first housing to rotate with the amplified torque, thereby driving the first finger bone 230 to rotate, thus increasing the torque of the finger. Further, in some embodiments, the first transmission assembly can be implemented using a gear assembly, realizing speed reduction and torque increase through the gear assembly to increase the torque transmitted from the first motor to the first rotating shaft. Further, the gear assembly can be a worm gear and worm assembly.

In an embodiment, the first finger bone 230 includes two first connecting plates 231. The first drive unit 221 is provided between the two first connecting plates 231. It can be understood that an accommodating space is formed between the two first connecting plates 231, and the first drive unit 221 is provided within the accommodating space. This makes the structure of the first joint 220 and the first finger bone 230 compact. At the same time, it needs to be explained that the first connecting plates 231 are fixedly provided at the first housing by means of screw locking.

In an embodiment, the second joint 240 includes a second drive unit 241. The second drive unit 241 includes a second housing, a second rotating shaft provided at the second housing, a second motor, and a second transmission assembly. The second rotating shaft is fixedly provided at the first finger bone 230. It needs to be explained that the second motor is fixedly provided at the second housing.

The second transmission assembly is connected to the second rotating shaft and the second motor and is configured to increase a torque transmitted from the second motor to the second rotating shaft. The second motor is configured to drive the second housing through the second rotating shaft to cause the second housing to rotate around the second rotating shaft. Further, in this embodiment, the second rotating shaft is fixedly provided at the first finger bone 230. At this time, when the second motor drives the second rotating shaft through the second transmission assembly, since the second rotating shaft is fixed, the second motor can rotate around the axis of the second rotating shaft. When the second motor rotates around the axis of the second rotating shaft, the second housing can also rotate following the rotation of the second motor. Further, the second finger bone 250 is fixedly provided at the second housing. When the second housing rotates, the second finger bone 250 can rotate following the second housing. Further, in some embodiments, the second transmission assembly can adopt a gear assembly to achieve the purpose of increasing torque. It can be understood that when the second joint 240 adopts the above structure, it can enable the second joint 240 to drive the second finger bone 250 to perform rotation to a maximum extent, thereby causing the finger to bend to a maximum extent, and under the action of the second transmission assembly, the torque of the second finger bone 250 can be increased, thereby increasing the gripping force of the finger.

In an embodiment, the finger further includes a third finger bone (not shown) and a third joint 260.

The third joint 260 includes a third drive unit 261. The third drive unit 261 includes a third housing, a third rotating shaft provided at the third housing, a third motor, and a third transmission assembly. The third rotating shaft is fixedly provided at the second finger bone 250, the third motor is fixedly provided at the third housing.

The third transmission assembly is connected to the third rotating shaft and the third motor and is configured to increase a torque transmitted from the third motor to the third rotating shaft. The third motor is configured to drive the third housing through the third rotating shaft to cause the third housing to rotate around an axis of the third rotating shaft. The third finger bone is fixedly provided at the third housing, is configured to rotate following the third housing, and is configured to cause the finger to bend towards the inner palm face. The third finger bone is fixedly provided at the third housing by means of screw locking. Further, in this embodiment, the third rotating shaft is fixedly provided at the second finger bone 250. At this time, when the third motor drives the third rotating shaft through the third transmission assembly, since the third rotating shaft is fixed, the third motor can rotate around the axis of the third rotating shaft. When the third motor rotates around the axis of the third rotating shaft, the third housing can also rotate following the rotation of the third motor. Further, the third finger bone is fixedly provided at the third housing. When the third housing rotates, the third finger bone can rotate following the third housing. Further, in some embodiments, the third transmission assembly can adopt a gear assembly to achieve the purpose of increasing torque. It can be understood that when the third joint 260 adopts the above structure, it can enable the third joint 260 to drive the third finger bone to perform rotation to a maximum extent, thereby causing the finger to bend to a maximum extent, and under the action of the third transmission assembly, the torque of the third finger bone can be increased, thereby increasing the gripping force of the finger.

In an embodiment, the second finger bone 250 includes two second connecting plates 251. The second drive unit 241 and the third drive unit 261 are provided between the two second connecting plates 251. The second connecting plates 251 are fixedly provided at the second housing by means of screw locking. It can be understood that at this time, an accommodating space can also be formed between the two second connecting plates 251.

Further, in some embodiments, when realizing bending of the finger towards the palm face, at this time, the axes of the first rotating shaft, the second rotating shaft, and the third rotating shaft are provided parallel to the palm face as much as possible, so that when the finger bends, the first finger bone 230, the second finger bone 250, and the third finger bone rotate towards the palm face.

In an embodiment, the finger includes a fourth drive unit 280 fixedly provided at the palm portion 100. The fourth drive unit 280 includes a fourth rotating shaft. The fourth rotating shaft is configured to drive the first mounting seat 210, to cause the finger to swing, and to cause two of said fingers to approach or move away from each other. Further, in this embodiment, the fourth drive unit 280 further includes a fourth motor. The fourth motor drives the fourth rotating shaft, and thereby drives the first mounting seat 210, to cause the finger to swing, the finger swings around the axis of the fourth rotating shaft. It needs to be explained that at this time, the axis of the fourth rotating shaft can be provided perpendicular to the palm face. However, this design is not limited thereto. In some embodiments, the axis of the fourth rotating shaft is provided at a preset angle with the palm face, and the angle can be an obtuse angle or an acute angle.

In an embodiment, the fourth drive unit 280 further includes a fourth housing fixedly provided at the palm portion 100, a fourth motor provided at the fourth housing, and a fourth transmission assembly. The fourth rotating shaft is provided at the fourth housing. The fourth motor is configured to drive the fourth rotating shaft through the fourth transmission assembly. The fourth transmission assembly is configured to increase a torque transmitted from the fourth motor to the fourth rotating shaft.

Further, in some embodiments, the fourth housing is fixedly provided at the palm portion 100 by means of screw locking. The fourth motor is fixedly provided at the fourth housing. It can be understood that in this embodiment, the fourth motor is fixed and immovable, and the fourth rotating shaft rotates. When the fourth rotating shaft rotates, it can drive the first mounting seat 210 to swing, thereby realizing the swinging of the finger. When two fingers are provided at the dexterous hand, and the two fingers swing at this time, the two fingers can be caused to approach or move away from each other. Further, the fourth transmission assembly can adopt a gear assembly to achieve the purpose of increasing torque. It can be understood that the torque generated by the fourth motor is amplified by the gear assembly and then acts on the fourth rotating shaft, thereby increasing the torque with which the fourth rotating shaft drives the first mounting seat 210.

Different from the above finger, the present application further provides a direct-drive finger applied to a dexterous hand. The dexterous hand includes a palm portion 100, and the finger is mounted to the palm portion 100.

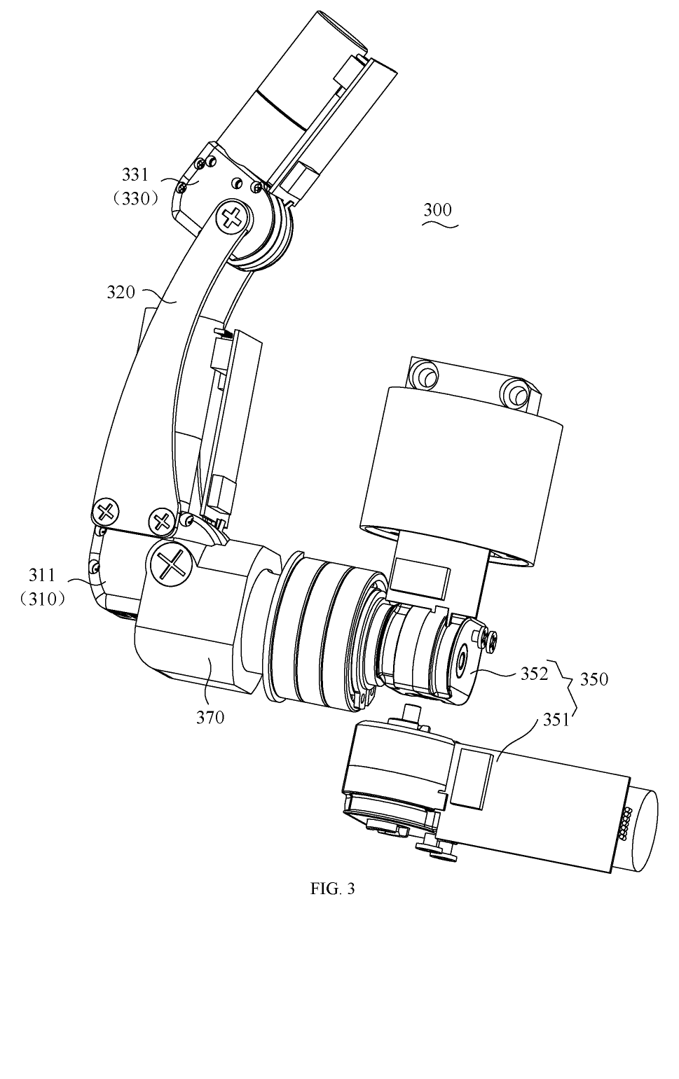

Referring to FIGS. 1 and 3, in an embodiment of the present application, the finger includes:
A second mounting seat 360 provided at the palm portion 100, a drive module 350, and a fifth joint 310 and a fifth finger bone 320 provided at the second mounting seat 360;

The drive module 350 includes a seventh drive unit 351 fixedly provided at the palm portion 100. The seventh drive unit 351 includes a seventh rotating shaft. The seventh rotating shaft is configured to drive the second mounting seat 360 to rotate around an axis of the seventh rotating shaft. The drive module 350 is configured to cause the finger to have a first position and a second position relative to the palm portion 100. It can be understood that the seventh drive unit 351 includes a seventh motor, the seventh motor drives the seventh rotating shaft to rotate, thereby realizing that the seventh rotating shaft drives the second mounting seat 360 to rotate around the axis of the seventh rotating shaft. It needs to be explained that the fifth joint 310 and the fifth finger bone 320 are both provided at the second mounting seat 360. When the second mounting seat 360 rotates, the fifth joint 310 and the fifth finger bone 320 can also rotate following it. Thus, the finger referred to in this embodiment can also perform rotation. Since the seventh motor drives the second mounting seat 360 to rotate around the axis of the seventh rotating shaft via the seventh rotating shaft, compared with the related art which adopts a manner of pushing and pulling via a screw rod and a moving rod to drive the finger to rotate, limitations on physical stroke (the limitation of the length of the screw rod itself) can be avoided. Compared with the related art, the rotation angle of the finger can be increased, thereby solving the technical problems existing in the related art. At the same time, this embodiment adopts the seventh motor to directly drive the seventh rotating shaft to realize the rotation of the second mounting seat 360 around the axis of the seventh rotating shaft, so as to realize the purpose of direct drive. Compared with the related art where a motor drives a rotating shaft and the rotating shaft drives a screw rod, this is more direct.

At the first position, the fifth joint 310 is configured to drive the fifth finger bone 320 to cause a fingertip of the finger to approach or move away from a peripheral side of the palm portion 100.

At the second position, the fifth joint 310 is configured to drive the fifth finger bone 320 to cause the fingertip of the finger to approach or move away from an inner palm face of the palm portion 100. It can be understood that when the finger including the fifth joint 310 is applied to a dexterous hand, it can be used as a thumb. Further, in some embodiments, the fifth joint 310 can adopt the manner of a screw rod and a moving rod to drive the fifth finger bone 320 to rotate, thereby causing: at the first position, the fingertip of the finger to approach or move away from the peripheral side of the palm portion 100; at the second position, the fingertip of the finger to approach or move away from the inner palm face of the palm portion 100.

In an embodiment, the seventh drive unit 351 further includes a seventh housing, a seventh motor provided at the seventh housing, and a seventh transmission assembly. The seventh rotating shaft is provided at the seventh housing. The seventh housing is fixedly provided at the palm portion 100, the seventh housing is fixedly provided at the palm portion 100 by means of screw locking, and the seventh motor is fixedly provided at the seventh housing.

The seventh motor drives the seventh rotating shaft through the seventh transmission assembly, and the seventh transmission assembly is configured to increase a torque transmitted from the seventh motor to the seventh rotating shaft; the seventh transmission assembly can adopt a gear assembly, achieving the purpose of increasing torque through the gear assembly. It needs to be explained that the torque generated by the seventh motor is amplified by the seventh transmission assembly and then transmitted to the seventh rotating shaft.

The drive module 350 further includes an eighth drive unit 352 and a third mounting seat 370. The eighth drive unit 352 includes an eighth housing, an eighth rotating shaft provided at the eighth housing, an eighth motor, and an eighth transmission assembly. The eighth housing is fixedly provided at the second mounting seat 360, the eighth housing is fixedly provided at the second mounting seat 360 by means of screw locking. It needs to be explained that a cavity is provided in the second mounting seat 360, and the eighth housing is fixedly provided in the cavity; the eighth rotating shaft is configured to drive the third mounting seat 370 to cause the third mounting seat 370 to rotate around an axis of the eighth rotating shaft.

The eighth motor drives the eighth rotating shaft through the eighth transmission assembly, and the eighth transmission assembly is configured to increase a torque transmitted from the eighth motor to the eighth rotating shaft. The fifth joint 310 is provided at the third mounting seat 370. It needs to be explained that since the eighth motor is provided at the eighth housing, and the eighth housing is fixedly provided at the second mounting seat 360, that is to say, at this time the eighth motor can also be fixedly provided at the second mounting seat 360. At this time, the eighth motor can drive the eighth rotating shaft through the eighth transmission assembly, thereby causing the eighth rotating shaft to drive the third mounting seat 370 to rotate, thus realizing the rotation of the fifth joint 310 and the fifth finger bone 320. It needs to be explained that at the first position, the eighth rotating shaft is parallel to the inner palm face; at the second position, the eighth rotating shaft is provided perpendicular to the inner palm face. Further, in some embodiments, the eighth transmission assembly can adopt a gear assembly, achieving the purpose of increasing torque through the gear assembly. It needs to be explained that since the third mounting seat 370 rotates around the axis of the eighth rotating shaft, at this time, in use, the third mounting seat 370 can realize 360-degree omnidirectional rotation, thereby driving the finger to perform omnidirectional rotation.

In an embodiment, the fifth joint 310 includes a fifth drive unit 311. The fifth drive unit 311 includes a fifth housing, a fifth rotating shaft provided at the fifth housing, a fifth motor, and a fifth transmission assembly. The fifth rotating shaft is fixedly provided at the third mounting seat 370. At the first position, an axis of the fifth rotating shaft is provided perpendicular to a palm face.

The fifth transmission assembly is connected to the fifth rotating shaft and the fifth motor and is configured to increase a torque transmitted from the fifth motor to the fifth rotating shaft. The fifth motor is configured to drive the fifth housing through the fifth rotating shaft to cause the fifth housing to rotate around the fifth rotating shaft. It needs to be explained that since the fifth rotating shaft is fixedly provided at the third mounting seat 370, at this time, when the fifth motor drives the fifth rotating shaft through the fifth transmission assembly, the fifth rotating shaft is fixed and immovable. At this time, the fifth motor can perform rotation around the axis of the fifth rotating shaft. When the fifth motor rotates around the axis of the fifth rotating shaft, the fifth finger bone 320 is fixedly provided at the fifth housing. At this time, the fifth housing can also rotate following it. The fifth finger bone 320 is fixedly provided at the fifth housing by means of screw locking. Further, in some embodiments, the fifth finger bone 320 can adopt the structure of the first finger bone 230, and the principles and effects thereof will not be repeated here.

In an embodiment, the finger further includes a sixth joint 330 and a sixth finger bone (not shown).

The sixth joint 330 includes a sixth drive unit 331. The sixth drive unit 331 includes a sixth housing, a sixth rotating shaft provided at the sixth housing, a sixth motor, and a sixth transmission assembly. The sixth rotating shaft is fixedly provided at the fifth finger bone 320. The sixth rotating shaft can be fixedly provided at the fifth finger bone 320 by means of screw locking. Similarly, this structure can also be adopted for the fixing manner of other rotating shafts and finger bones.

The sixth transmission assembly is connected to the sixth rotating shaft and the sixth motor and is configured to increase a torque transmitted from the sixth motor to the sixth rotating shaft. The sixth motor is configured to drive the sixth housing through the sixth rotating shaft to cause the sixth housing to rotate around the sixth rotating shaft. It needs to be explained that the sixth motor drives the sixth rotating shaft through the sixth transmission assembly. Since the sixth rotating shaft is fixed and immovable, at this time, the sixth motor can rotate around the sixth rotating shaft. When the sixth motor rotates around the sixth rotating shaft, at this time the sixth housing can rotate following it. Since the sixth finger bone is fixedly provided at the sixth housing, at this time the sixth finger bone can rotate following the sixth housing. When the sixth finger bone rotates, the bending of the finger can be realized.

However, this design is not limited thereto. In some embodiments, the finger including the fifth joint 310 and the fifth finger bone 320 can further include a seventh joint and a seventh finger bone.

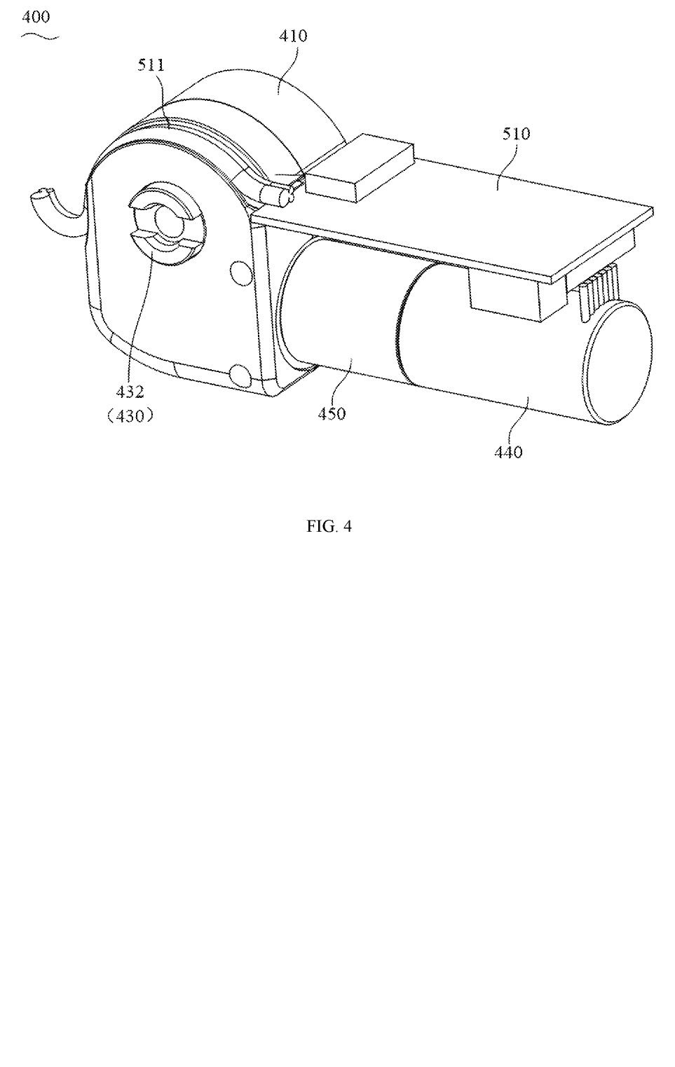

Further, in some embodiments, referring to FIGS. 4-9, the aforementioned drive unit 400 can all adopt the following structure. In use, the drive units 400 of some joints may differ in size. Further, for the convenience of describing the drive unit 400, the words "first" to "eighth" are omitted here. Further, the drive unit 400 includes a housing 410, a rotating shaft, a motor 440, and a transmission assembly.

The housing 410 has a first accommodating cavity and a second accommodating cavity communicating therein. Through holes are formed on both opposite side walls of the second accommodating cavity.

The transmission assembly includes a toroidal enveloping worm 420, a helical gear shaft 430, and a planetary reduction structure 450. The helical gear shaft 430 includes a helical gear portion 431 and a shaft portion 432. The aforementioned rotating shaft is configured as the shaft portion in the helical gear shaft 430.

The toroidal enveloping worm 420 is provided in the first accommodating cavity, and one end of the toroidal enveloping worm 420 is exposed from the housing 410. The helical gear shaft 430 is provided in the second accommodating cavity. The helical gear shaft 430 meshes with the toroidal enveloping worm 420. Both ends of the helical gear shaft 430 respectively pass through the two through holes. The axis of the toroidal enveloping worm 420 and the axis of the helical gear shaft 430 are provided perpendicular to each other. The planetary reduction structure 450 is connected to an output shaft of the motor 440 and the end of the toroidal enveloping worm 420 exposed from the housing 410.

Further, according to the working scenario of the rotating shaft, when the rotating shaft is fixed and immovable, the motor 440 can rotate around the axis of the rotating shaft, thereby driving the housing 410 to rotate around the axis of the rotating shaft. When the rotating shaft rotates, at this time the motor 440 and the housing 410 are fixed and immovable. At this time, the motor 440 can drive the rotating shaft, causing the rotating shaft to drive components provided at the rotating shaft to rotate, such as the first mounting seat 210 and the third mounting seat 370.

Further, the housing 410 includes two side plates. The two side plates enclose to form the first accommodating cavity and the second accommodating cavity. The two side plates are connected by screws, so as to facilitate the assembly of the drive unit 400. That is, the toroidal enveloping worm 420, the helical gear shaft 430, and the motor 440 can be first assembled onto one of the side plates, and then the two side plates are connected to complete the assembly.

The axis of the toroidal enveloping worm 420 and the axis of the helical gear shaft 430 are provided perpendicular to each other. The perpendicular arrangement can better install the motor 440 at the robot finger joint, reducing the space size required for the installation of the drive unit 400, facilitating the installation of the drive unit 400 in the space formed by the finger bones, thereby reducing the size of the finger bones, and thus realizing the reduction of the finger size, achieving the goal of miniaturized design of the dexterous hand, and further solving the technical problems existing in the related art.

The planetary reduction structure 450 can reduce the high-speed rotation of the motor 440 to a lower speed suitable for finger joint movement, while correspondingly increasing the output torque, enabling the finger joint to generate sufficient force for precise motion control.

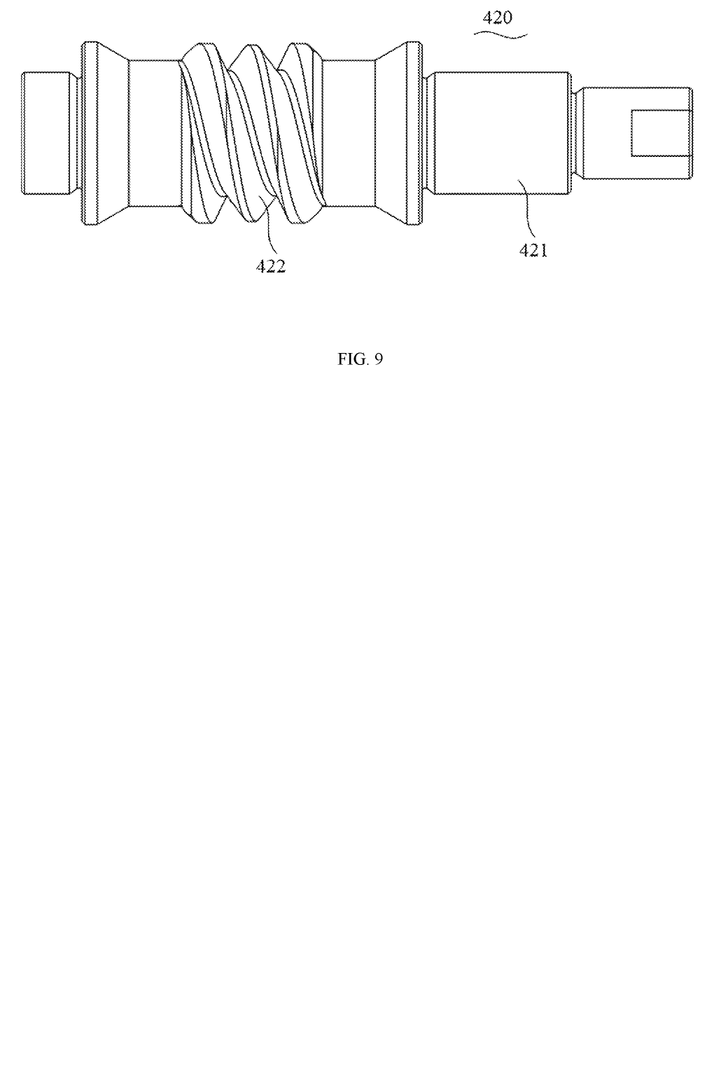

Specifically, in an embodiment, referring to FIG. 9, the toroidal enveloping worm 420 includes a rod body 421 and a plurality of teeth 422 provided at the rod body 421. The plurality of teeth 422 form a transmission section. The helical gear shaft 430 meshes with the transmission section. From the middle of the transmission section to both ends of the transmission section, the outer diameter of the teeth 422 gradually increases. That is, the height of the teeth 422 at both ends of the transmission section is greater than the height of the teeth 422 in the middle of the transmission section. The plurality of teeth 422 present a substantially arc-shaped distribution. In this way, when the helical gear shaft 430 meshes with the toroidal enveloping worm 420, multi-tooth meshing can be realized, thereby generating a larger output torque, and further amplifying the torque transmitted from the motor 440 to the rotating shaft. In addition, by setting the sizes of the toroidal enveloping worm 420 and the helical gear shaft 430, the toroidal enveloping worm 420 and helical gear transmission mechanism can have a self-locking capability, without the need to design an additional locking mechanism.

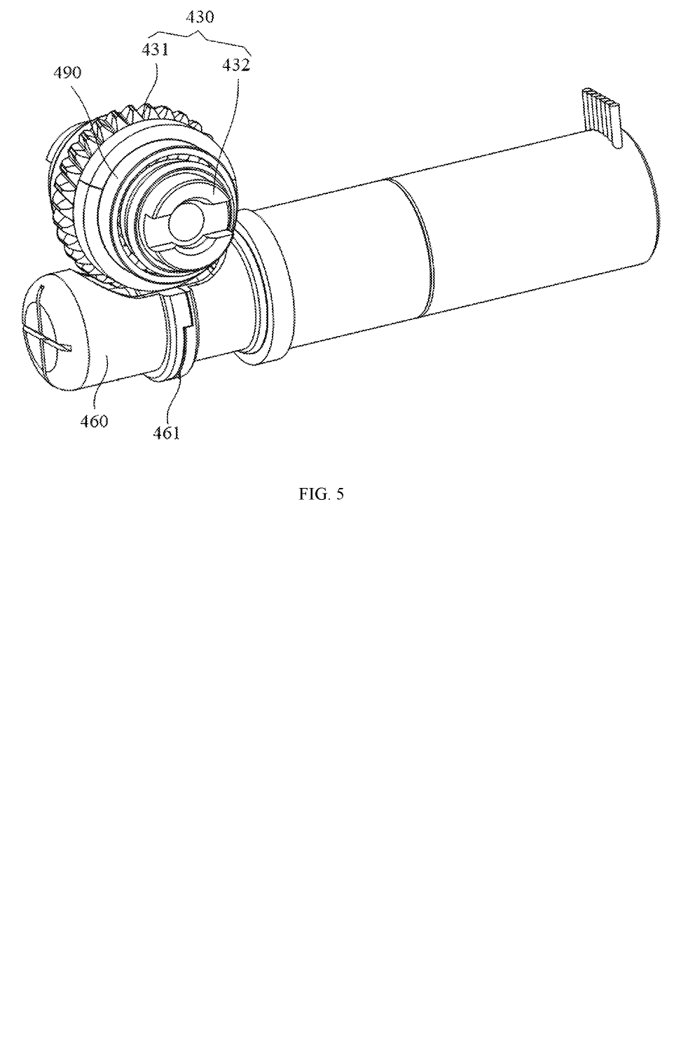

Further, in an embodiment, referring to FIGS. 5, 6, and 8, the drive unit 400 further includes an eccentric sleeve 460. The eccentric sleeve 460 is rotatably provided in the first accommodating cavity. The middle part of the eccentric sleeve 460 is provided with a through hole. Both ends of the eccentric sleeve 460 are provided with eccentric holes. The toroidal enveloping worm 420 is provided inside the eccentric sleeve 460. Both ends of the toroidal enveloping worm 420 are rotatably provided in the eccentric holes respectively. Part of the structure of the helical gear shaft 430 passes through the through hole to mesh with the toroidal enveloping worm 420. It can be understood that the eccentric hole is a hole whose center is not the same as the axis of the eccentric sleeve 460. In this way, by rotatably disposing both ends of the toroidal enveloping worm 420 in the eccentric holes respectively, when rotating the eccentric sleeve 460, the toroidal enveloping worm 420 will rotate around the axis of the eccentric sleeve 460 under the restriction of the eccentric holes, that is, the distance between the axis of the toroidal enveloping worm 420 and the axis of the helical gear shaft 430 can be changed, thereby being applicable to finger bones of different sizes. Wherein, for the convenience of installing and rotating the eccentric sleeve 460, two oppositely provided round holes communicating with the first accommodating cavity are provided at the housing 410. The eccentric sleeve 460 includes a first sleeve body 462 and a second sleeve body 463. The first sleeve body 462 and the second sleeve body 463 are spliced to form the eccentric sleeve 460. The first sleeve body 462 and the second sleeve body 463 are exposed from the housing 410 through the two round holes respectively. One end of the toroidal enveloping worm 420 passes through the first sleeve body 462 to connect with the planetary reduction structure 450. Cross slots are provided at opposite sides of the end of the second sleeve body 463 exposed from the housing 410. In this way, tools such as a screwdriver can be used to rotate the second sleeve body 463, thereby driving the toroidal enveloping worm 420 inside the eccentric sleeve 460 to rotate, achieving the purpose of changing the distance between the axis of the toroidal enveloping worm 420 and the axis of the helical gear shaft 430.

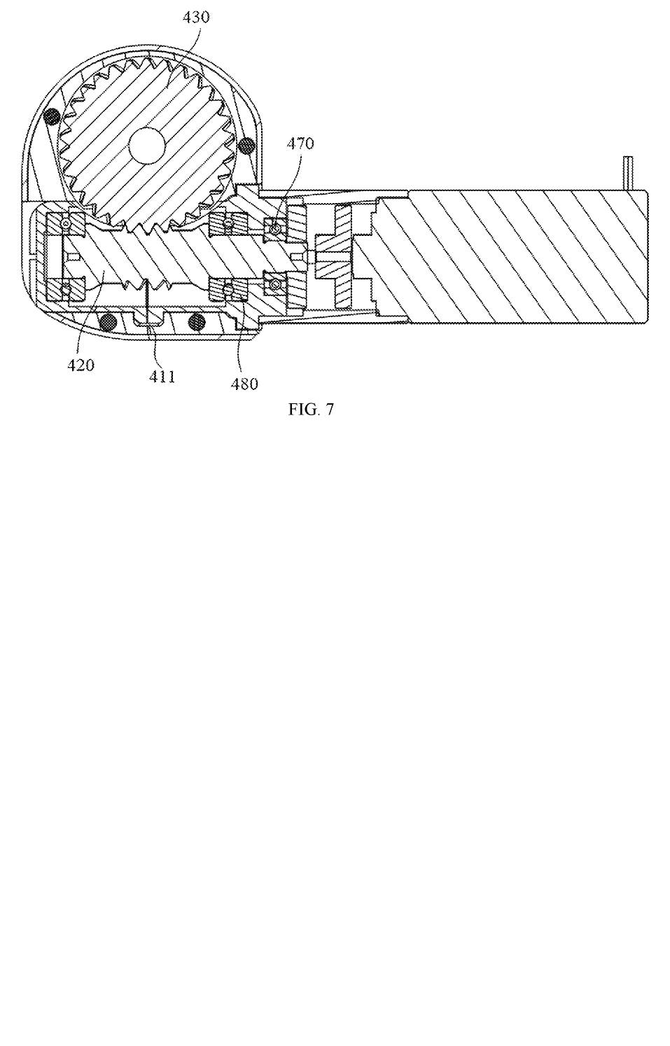

In an embodiment, referring to FIGS. 5 and 7, an annular groove 411 is formed on the inner wall of the first accommodating cavity; an annular protrusion 461 is formed on the outer wall of the eccentric sleeve 460. The annular protrusion 461 is engaged in the annular groove 411. The cooperation of the annular protrusion 461 and the annular groove 411 can provide a mechanical lock, thereby restricting the position of the eccentric sleeve 460 relative to the housing 410. In this way, during the rotation of the eccentric sleeve 460, it can be ensured that it will not move relative to the housing 410, and during the process of the motor 440 driving the toroidal enveloping worm 420 to rotate, the eccentric sleeve 460 will also not shift.

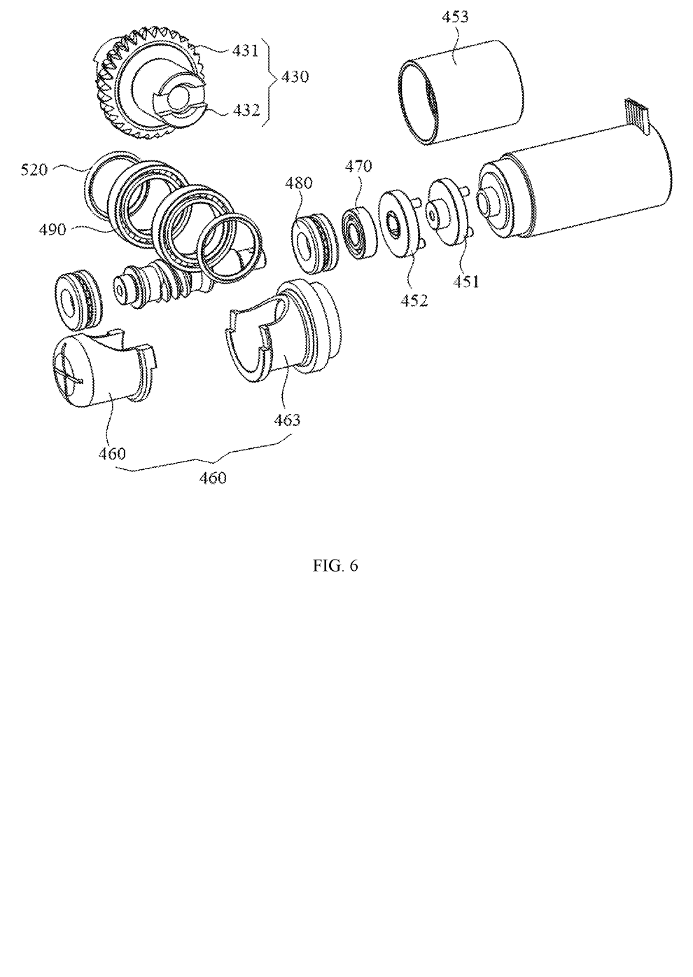

Further, in an embodiment, referring to FIGS. 6 and 7, an installation hole communicating with the eccentric hole is provided at the side of the eccentric sleeve 460 facing the motor 440. One end of the toroidal enveloping worm 420 passes through the installation hole to connect with the planetary reduction structure 450; the drive unit 400 further includes a positioning bearing 470. The positioning bearing 470 is provided in the installation hole and sleeved on the toroidal enveloping worm 420. The positioning bearing 470 is provided in the installation hole and sleeved on the toroidal enveloping worm 420, providing extra support and positioning. This helps reduce wobble and deformation of the toroidal enveloping worm 420 during high-speed rotation or when bearing large torque, enhances the structural stability of the entire transmission mechanism, and ensures that the finger joint can still operate stably under working conditions of high load or high precision requirements.

In order to improve the service life, in this embodiment, referring to FIGS. 6, 7, and 8, the drive unit 400 further includes two first bearings 480. The two first bearings 480 are provided in the first accommodating cavity. The two first bearings 480 are respectively sleeved on both ends of the toroidal enveloping worm 420. Similarly, the drive unit 400 further includes two second bearings 490. The two second bearings 490 are provided in the second accommodating cavity. The two second bearings 490 are respectively sleeved on both ends of the helical gear shaft 430. The arrangement of the first bearings 480 and the second bearings 490 can reduce direct contact between the toroidal enveloping worm 420 and the inner wall of the housing 410, and between the helical gear shaft 430 and the inner wall of the housing 410, thereby reducing friction and wear, improving rotation efficiency, and also helping to extend service life. The first bearings 480 and the second bearings 490 can also provide stable support points, helping to maintain the positions of the toroidal enveloping worm 420 and the helical gear shaft 430 and ensuring stability. Wherein, when the eccentric sleeve 460 is provided, the first bearings 480 are correspondingly provided inside the eccentric sleeve 460.

Further, in an embodiment, referring to FIG. 4, the drive unit 400 further includes a drive board 510. The drive board 510 is electrically connected to the motor 440; an accommodating slot is formed on the housing 410. The accommodating slot is configured to accommodate a connecting wire 511 of the drive board 510. The drive board 510 is electrically connected to the motor 440, and accommodates the connecting wire 511 of the drive board 510 through the accommodating slot on the housing 410. This design realizes compact integration of electrical components. Within a limited space, the drive board 510 and its connecting wire 511 are reasonably laid out, avoiding clutter of lines and external interference, making the entire transmission mechanism cleaner and more orderly, improving space utilization efficiency, and realizing closed-loop control of the direct-drive finger by using the drive board to realize closed-loop control of the drive unit 400.

Specifically, in an embodiment, referring to FIG. 6, the planetary reduction structure 450 includes a first planet disk 451, a second planet disk 452, three first planet gears (not shown in the figure), three second planet gears (not shown in the figure), a first sun gear (not shown in the figure), and a second sun gear (not shown in the figure); a first output rod and three first input rods are respectively provided at both sides of the first planet disk 451. The second planet disk 452 is provided with three second input rods. Each first planet gear is sleeved on a first input rod. Each second planet gear is sleeved on a second input rod. The first sun gear is sleeved on the output shaft of the motor 440 and meshes with the three first planet gears. The second sun gear is sleeved on the first output rod and meshes with the three second planet gears. The toroidal enveloping worm 420 is connected to the end exposed from the housing 410 and is limitedly inserted into the second planet disk 452. Through the meshing of the first sun gear with the three first planet gears, and the meshing of the second sun gear with the three second planet gears, two-stage reduction is realized. This multi-stage reduction structure can realize a large reduction ratio within a relatively small volume, thereby reducing the high-speed rotation of the motor 440 to a lower rotation speed suitable for finger joint movement, while significantly increasing the output torque, enabling the finger joint to produce sufficient force for precise motion control. In addition, the planetary reduction structure 450 further includes a protective shell 453. The protective shell 453 is connected to the housing 410 and the outer shell of the motor 440. The first planet disk 451, the second planet disk 452, the three first planet gears, the three second planet gears, the first sun gear, and the second sun gear are all located inside the protective shell 453.

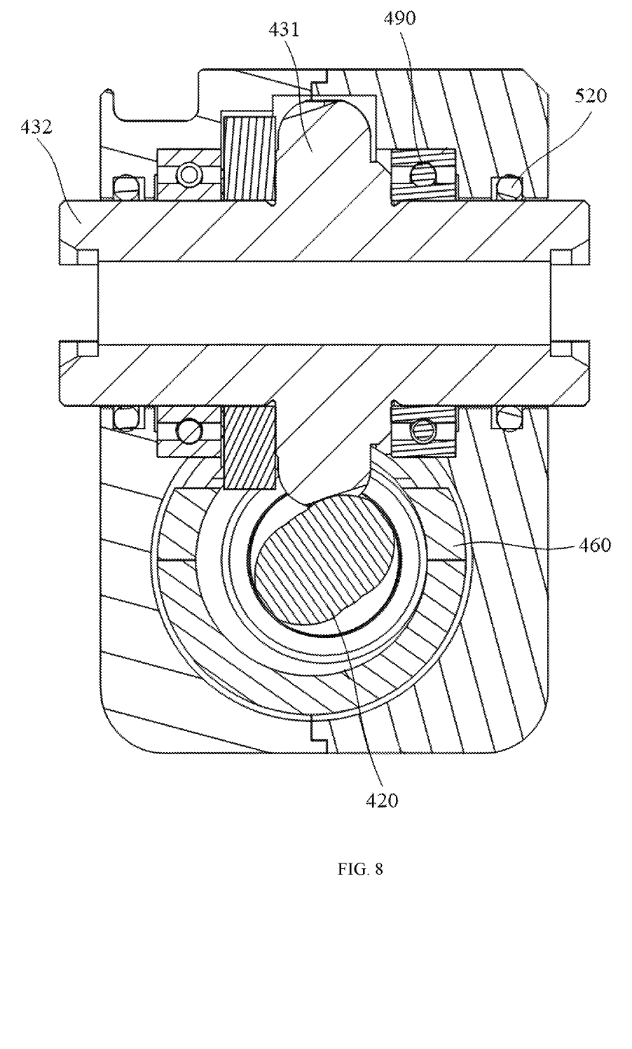

Further, in an embodiment, referring to FIGS. 6 and 8, an annular installation groove is formed on the hole wall of the through hole; the toroidal enveloping worm 420 helical gear transmission mechanism of the robot finger joint further includes two sealing rings 520. The two sealing rings 520 are respectively sleeved on both ends of the helical gear shaft 430. Each sealing ring 520 is sealingly embedded in an annular installation groove. The sealing rings 520 are sleeved on both ends of the helical gear shaft 430, and each sealing ring 520 is sealingly embedded in an annular installation groove, which can effectively prevent dust, moisture, or other contaminants from entering the first accommodating cavity, protecting various components from wear or corrosion. In addition, lubricating oil is usually provided in the first accommodating cavity and the second accommodating cavity. The lubricating oil can provide lubrication for the toroidal enveloping worm 420, the helical gear shaft 430, the first bearings 480, and the second bearings 490. In this case, the provision of the sealing rings 520 can also avoid leakage of lubricating oil from the inside, ensuring that various components receive continuous lubrication, helping to extend the service life of various components.

Specifically, in an embodiment, the transmission ratio of the drive unit 400 ranges from 10:1 to 30:1. That is, it has a relatively high reduction ratio, which can provide precise speed control, thereby ensuring the accuracy of robot finger activities. In addition, it also ensures the flexibility and adaptability of the drive unit 400 in different application scenarios.

The distance between the axis of the toroidal enveloping worm 420 and the axis of the helical gear shaft 430 ranges from 3mm to 8mm. That is, the center distance between the toroidal enveloping worm 420 and the helical gear shaft 430 ranges from 3mm to 8mm. In this way, by changing the center distance between the toroidal enveloping worm 420 and the helical gear shaft 430, the transmission mechanism can be adapted to robot fingers of different sizes.

The modulus of both the toroidal enveloping worm 420 and the helical gear shaft 430 is m, 0.15≤m≤0.5. A modulus within this range can ensure the precision and stability of the transmission mechanism.

The present application further provides a fully direct-drive dexterous hand. Referring to FIG. 1, the dexterous hand includes a palm portion 100, at least one said first finger 200, and at least one said second finger 300 provided at the palm portion 100. The first finger 200 includes the first joint 220. The second finger 300 includes the fifth joint 310. For the specific structures of the first finger 200 and the second finger 300, reference is made to the above embodiments. Since the dexterous hand adopts all the technical solutions of all the above embodiments, it at least has all the beneficial effects brought by the technical solutions of the above embodiments, which will not be repeated here. Further, in some embodiments, the palm portion 100 is provided with an installation cavity. The first mounting seat 210 and the second mounting seat 360 are both provided in the installation cavity.

The above are only exemplary embodiments of the present application and do not limit the protection scope of the present application. Any equivalent structural transformation made under the technical concept of the present application using the contents of the description and drawings of the present application, or direct/indirect application in other related technical fields, are all included in the protection scope of the present application.

What is claimed is:

1. A direct-drive finger, applied to a dexterous hand, wherein the dexterous hand comprises a palm portion, and the direct-drive finger is mounted to the palm portion; the direct-drive finger comprises:
a first mounting seat connected to the palm portion; and
a first joint, a first finger bone, a second joint, and a second finger bone connected in sequence in a direction extending away from the palm portion;
wherein the first joint comprises a first drive unit, and the first drive unit comprises a first housing, a first motor, and a first rotating shaft provided at the first housing; the first finger bone is fixedly provided at the first housing; the first housing is connected to the first mounting seat via the first rotating shaft; and the first motor is configured to drive the first housing via the first rotating shaft to cause the first housing to rotate relative to the first mounting seat around an axis of the first rotating shaft, and to drive the direct-drive finger to rotate towards an inner palm face; and
the second joint is configured to drive the second finger bone to cause the direct-drive finger to bend towards the inner palm face.

2. The direct-drive finger according to claim 1, wherein the first drive unit further comprises a first transmission assembly; the first motor is provided at the first housing; the first rotating shaft is fixedly provided at the first mounting seat; and the first transmission assembly is connected to the first rotating shaft and the first motor, to increase a torque transmitted from the first motor to the first rotating shaft; and
the first finger bone comprises two first connecting plates, and the first drive unit is provided between the two first connecting plates.

3. The direct-drive finger according to claim 2, wherein the second joint comprises a second drive unit, and the second drive unit comprises:
a second housing, a second rotating shaft provided at the second housing, a second motor, and a second transmission assembly, wherein the second rotating shaft is fixedly provided at the first finger bone;
wherein the second transmission assembly is connected to the second rotating shaft and the second motor, to increase a torque transmitted from the second motor to the second rotating shaft; and the second motor is configured to drive the second housing via the second rotating shaft, to cause the second housing to rotate around the second rotating shaft; and
the second finger bone is configured to rotate following the second housing, and the second finger bone is fixedly provided at the second housing.

4. The direct-drive finger according to claim 3, wherein the direct-drive finger further comprises a third finger bone and a third joint;
the third joint comprises a third drive unit, and the third drive unit comprises a third housing, a third rotating shaft provided at the third housing, a third motor, and a third transmission assembly, wherein the third rotating shaft is fixedly provided at the second finger bone;
the third transmission assembly is connected to the third rotating shaft and the third motor, to increase a torque transmitted from the third motor to the third rotating shaft; and the third motor is configured to drive the third housing via the third rotating shaft, to cause the third housing to rotate around an axis of the third rotating shaft; the third finger bone is fixedly provided at the third housing; the third finger bone is configured to rotate following the third housing, and the third finger bone is configured to cause the direct-drive finger to bend towards the inner palm face; and
the second finger bone comprises two second connecting plates, and the second drive unit and the third drive unit are provided between the two second connecting plates.

5. The direct-drive finger according to claim 1, wherein the direct-drive finger comprises a fourth drive unit fixedly provided at the palm portion, and the fourth drive unit comprises a fourth rotating shaft, the fourth rotating shaft is configured to drive the first mounting seat to cause the direct-drive finger to swing, and cause two of the fingers to approach or move away from each other.

6. The direct-drive finger according to claim 5, wherein the fourth drive unit further comprises a fourth housing fixedly provided at the palm portion, a fourth motor provided at the fourth housing, and a fourth transmission assembly; the fourth rotating shaft is provided at the fourth housing; and the fourth motor is configured to drive the fourth rotating shaft via the fourth transmission assembly, and the fourth transmission assembly is configured to increase a torque transmitted from the fourth motor to the fourth rotating shaft.

7. A direct-drive finger, applied to a dexterous hand, wherein the dexterous hand comprises a palm portion, and the direct-drive finger is mounted to the palm portion; the direct-drive finger comprises:
a second mounting seat provided at the palm portion;
a drive module;
a fifth joint provided at the second mounting seat; and
a fifth finger bone;
wherein the drive module comprises a seventh drive unit fixedly provided at the palm portion, and the seventh drive unit comprises a seventh rotating shaft; the seventh rotating shaft is configured to drive the second mounting seat to rotate around an axis of the seventh rotating shaft, and the drive module is configured to place the direct-drive finger in a first position or a second position relative to the palm portion;
in the first position, the fifth joint is configured to drive the fifth finger bone to cause a fingertip of the direct-drive finger to approach or move away from a peripheral side of the palm portion; and
in the second position, the fifth joint is configured to drive the fifth finger bone to cause the fingertip of the direct-drive finger to approach or move away from an inner palm face of the palm portion.

8. The direct-drive finger according to claim 7, wherein the seventh drive unit further comprises a seventh housing, a seventh motor provided at the seventh housing, and a seventh transmission assembly; wherein the seventh rotating shaft is provided at the seventh housing, and the seventh housing is fixedly provided at the palm portion;
the seventh motor is configured to drive the seventh rotating shaft via the seventh transmission assembly, and the seventh transmission assembly is configured to increase a torque transmitted from the seventh motor to the seventh rotating shaft;
the drive module further comprises an eighth drive unit and a third mounting seat; the eighth drive unit comprises an eighth housing, an eighth rotating shaft provided at the eighth housing, an eighth motor, and an eighth transmission assembly; wherein the eighth housing is fixedly provided at the second mounting seat, and the eighth rotating shaft is configured to drive the third mounting seat to cause the third mounting seat to rotate around an axis of the eighth rotating shaft;
the eighth motor is configured to drive the eighth rotating shaft via the eighth transmission assembly, and the eighth transmission assembly is configured to increase a torque transmitted from the eighth motor to the eighth rotating shaft; and the fifth joint is provided at the third mounting seat;
in the first position, the eighth rotating shaft is parallel to the inner palm face; and
in the second position, the eighth rotating shaft is perpendicular to the inner palm face.

9. The direct-drive finger according to claim 8, wherein the fifth joint comprises a fifth drive unit, and the fifth drive unit comprises a fifth housing, a fifth rotating shaft provided at the fifth housing, a fifth motor, and a fifth transmission assembly; wherein the fifth rotating shaft is fixedly provided at the third mounting seat; and in the first position, an axis of the fifth rotating shaft is provided perpendicular to a palm face;
the fifth transmission assembly is connected to the fifth rotating shaft and the fifth motor and the fifth transmission assembly, to increase a torque transmitted from the fifth motor to the fifth rotating shaft; and the fifth motor is configured to drive the fifth housing via the fifth rotating shaft to cause the fifth housing to rotate around the fifth rotating shaft;
the fifth finger bone is configured to rotate following the fifth housing, and the fifth finger bone is fixedly provided at the fifth housing; and
wherein the direct-drive finger further comprises a sixth joint and a sixth finger bone;
the sixth joint comprises a sixth drive unit; the sixth drive unit comprises a sixth housing, a sixth rotating shaft provided at the sixth housing, a sixth motor, and a sixth transmission assembly, and the sixth rotating shaft is fixedly provided at the fifth finger bone;
the sixth transmission assembly is connected to the sixth rotating shaft and the sixth motor, to increase a torque transmitted from the sixth motor to the sixth rotating shaft; and the sixth motor is configured to drive the sixth housing via the sixth rotating shaft to cause the sixth housing to rotate around the sixth rotating shaft; and
the sixth finger bone is configured to rotate following the sixth housing, and the sixth finger bone is fixedly provided at the sixth housing.

10. A fully direct-drive dexterous hand, comprising:
a palm portion;
at least one first finger provided at the palm portion; and
at least one second finger;
wherein the first finger comprises a first mounting seat connected to the palm portion; and a first joint, a first finger bone, a second joint, and a second finger bone connected in sequence in a direction extending away from the palm portion; wherein the first joint comprises a first drive unit, and the first drive unit comprises a first housing, a first motor, and a first rotating shaft provided at the first housing; the first finger bone is fixedly provided at the first housing; the first housing is connected to the first mounting seat via the first rotating shaft; and the first motor is configured to drive the first housing via the first rotating shaft to cause the first housing to rotate relative to the first mounting seat around an axis of the first rotating shaft, and to drive the at least one first finger to rotate towards an inner palm face; and the second joint is configured to drive the second finger bone to cause the at least one first finger to bend towards the inner palm face; and
wherein the second finger comprises a second mounting seat provided at the palm portion; a drive module; a fifth joint provided at the second mounting seat; and a fifth finger bone; wherein the drive module comprises a seventh drive unit fixedly provided at the palm portion, and the seventh drive unit comprises a seventh rotating shaft; the seventh rotating shaft is configured to drive the second mounting seat to rotate around an axis of the seventh rotating shaft, and the drive module is configured to place the at least one second finger in a first position or a second position relative to the palm portion; in the first position, the fifth joint is configured to drive the fifth finger bone to cause a fingertip of the at least one second finger to approach or move away from a peripheral side of the palm portion; and in the second position, the fifth joint is configured to drive the fifth finger bone to cause the fingertip of the at least one second finger to approach or move away from an inner palm face of the palm portion.
